(19) United States
(12) Patent Application Publication
(10) Pub. No.: US 2025/0006441 A1
(43) Pub. Date: Jan. 2, 2025

(54) FAST CIRCUIT CUTOFF DEVICE

(71) Applicant: HANGZHOU JINGCHENG NEW ENERGY TECHNOLOGY CO.,LTD, Hangzhou (CN)

(72) Inventors: Chaolong LIU, Hangzhou (CN); Ke ZHANG, Hangzhou (CN)

(21) Appl. No.: 18/757,620

(22) Filed: Jun. 28, 2024

(30) Foreign Application Priority Data
Jun. 30, 2023 (CN) 202310801233.0

(51) Int. Cl. H01H 33/60; H01H 33/53

(52) U.S. Cl. CPC H01H 33/60; H01H 33/53

(57) ABSTRACT

A fast circuit cutoff device includes a housing, an igniter, a piston, at least one arc extinguishing component and a conductor, the igniter, the piston and the at least one arc extinguishing component are provided in the housing, the conductor penetrates through the housing, the igniter and the piston are located on a first side of the conductor, and the at least one arc extinguishing component is provided on a second side of the conductor; the igniter is configured to drive the piston to move towards the arc extinguishing component to a blocking state, so as to cut a part of the conductor into fragments by the piston; and under the blocking state, ends of the fragments are inserted into the at least one arc extinguishing component under a compression of the piston.

### CROSS-REFERENCE TO RELATED APPLICATION

This application claims priority to Chinese patent application No. 202310801233.0, filed on Jun. 30, 2023, and titled “FAST CIRCUIT CUTOFF DEVICE”. The content of the above identified applications is hereby incorporated herein in its entirety by reference.

### TECHNICAL FIELD

The present disclosure relates to the field of electric power related technology, and in particular, to a fast circuit cutoff device.

### BACKGROUND

Circuit cutting devices are used to quickly cut off circuits and achieve insulation when encountering safety issues. In order to improve an arc extinguishing ability of some circuit cutting-off devices, an arc extinguishing media (such as metal wires, arc extinguishing grid pieces, etc.) or cutting ends are added, in which the former can extinguish the arc in contact, thereby achieving a rapid arc extinguishing effect, while the latter can cut off some conductors to increase the current breaking ability.

However, after the conductor fragments cut off by the circuit cutting-off device are in contact with the arc extinguishing media, the arc carried by a fragment may be conducted to the arc extinguishing media through a contact surface between the fragment and the arc extinguishing media. If the arc is conducted to the arc extinguishing medium and in contact with the metal powder generated during the conductor cutting, there is a risk of arc reignition, leading to a decrease in insulation performance and even causing the current cutting device to explode.

### SUMMARY

According to various embodiments of the present disclosure, a fast circuit cutoff device is provided.

The present disclosure provides a fast circuit cutoff device. The fast circuit cutoff device includes a housing, an igniter, a piston, at least one arc extinguishing component and a conductor. The igniter, the piston and the at least one arc extinguishing component are provided in the housing. The conductor penetrates through the housing. The igniter and the piston are located on a first side of the conductor. The at least one arc extinguishing component is provided on a second side of the conductor. The igniter is configured to drive the piston to move towards the arc extinguishing component to a blocking state, so as to cut a part of the conductor into fragments by the piston. Under the blocking state, ends of the fragments are inserted into the at least one arc extinguishing component under a compression of the piston.

In some embodiments, the housing includes an arc extinguish chamber. The at least one arc extinguishing component is disposed in the arc extinguish chamber. The arc extinguish chamber includes a guiding surface inclined relative to a movement direction of the piston. The fragments are deflected by abutting against the guiding surface.

In some embodiments, an accommodating chamber is defined on a side of the piston towards the conductor. The fragments are accommodated in the accommodating chamber. Under the blocking state, the arc extinguishing component abuts against the piston to block the accommodating chamber.

In some embodiments, the accommodating chamber includes a blocking surface. Under the blocking state, the blocking surface abuts against one of fracture surfaces of the fragments along the movement direction of the piston.

In some embodiments, an end of the piston towards the arc extinguishing component includes a columnar portion.

In some embodiments, a protrusion portion is fixedly provided in the arc extinguish chamber. The guiding surface is a sidewall of the protrusion portion. The accommodating chamber includes a fitting cavity corresponding to the protrusion portion. Under the blocking state, the protrusion portion is inserted into the fitting cavity and abuts against an inner wall of the fitting cavity.

In some embodiments, the accommodating chamber further includes a fragment-holding cavity defined on the inner wall of the fitting cavity. The blocking surface is an inner wall of the fragment-holding cavity towards the igniter. Under the blocking state, the fragments are accommodated in the fragment-holding cavity.

In some embodiments, at least one protrusion portion capable of inserting into the accommodating chamber is fixedly provided in the arc extinguish chamber. The at least one protrusion portion includes a dividing edge, and the dividing edge of the at least one protrusion portion is configured to further cut the part of the conductor cut by the piston into a plurality of fragments when the piston moves towards the arc extinguishing component.

In some embodiments, one protrusion portion is fixedly provided in the arc extinguish chamber and configured to further cut the part of the conductor cut by the piston into two fragments.

In some embodiments, under the blocking state, the at least one protrusion portion abuts against an inner wall of the accommodating chamber, so as to divide the accommodating chamber into a plurality of fragment-holding cavities separated from each other. Each of the plurality of fragment-holding cavities is configured to accommodate one of the plurality of fragments.

Details of one or more embodiments of present disclosure are presented in the following drawings and descriptions. And other features, objectives and advantages of this disclosure will become apparent from the description, drawings and claims.

### BRIEF DESCRIPTION OF THE DRAWINGS

For a better description and illustration of embodiments and/or examples of those disclosures disclosed herein, reference may be made to one or more attached drawings. Additional details or examples used to describe the drawings should not be considered as limiting the scope of any of the disclosed disclosures, currently described embodiments and/or examples, and currently understood best modes of these disclosures.

FIG. 1 is a cross-sectional schematic diagram of a fast circuit cutoff device in an initial state according to the present disclosure.

FIG. 2 is a cross-sectional schematic diagram of a fast circuit cutoff device hiding one of arc extinguishing components in a blocking state according to the present disclosure.

FIG. 3 is a schematic diagram of a bottom housing of the fast circuit cutoff device in FIG. 1.

FIG. 4 is an enlarged view of a bottom housing of the fast circuit cutoff device in FIG. 1.

FIG. 5 is a schematic diagram of a piston of the fast circuit cutoff device in FIG. 1.

FIG. 6 is an enlarged view of a piston of the fast circuit cutoff device in FIG. 1.

Reference signs are as follows:

100 represents a housing; 110 represents a top housing; 120 represents a conductor-fixing component; 121 represents a through hole; 130 represents a bottom housing; 10 represents an igniter; 20 represents a piston; 21 represents an accommodating chamber; 21a represents a fragment-holding cavity; 211a represents a blocking face; 21b represents a fitting cavity; 22 represents a columnar portion; 23 represents a cutting portion; 23a represents a first cutting portion; 23b represents a second cutting portion; 231 represents a cutting edge; 24 represents a piston avoidance slot; 30 represents an arc extinguish chamber; 31 represents an arc extinguishing component; 32 represents a spacer assembly; 321 represents a protrusion portion; 321a represents a guiding face; 321b represents a dividing edge; 322 represents a spacer; 322a represents a spacer avoidance slot; 40 represents a conductor; and 41 represents a fragment.

### DETAILED DESCRIPTION

In order to make the above objectives, features, and advantages of the present disclosure more obvious and understandable, a detailed explanation of the specific embodiments of the present disclosure will be provided below in combination with the following drawings. There are a lot of specific details in the following description to conducive to fully understand the present disclosure. However, the present disclosure can be implemented in many other ways different from the described ways herein, and the skilled in the art can make similar improvements without departing from the substantial spirit of the present disclosure. Therefore, the present disclosure is not limited by the specific embodiments disclosed below.

In the description of the present disclosure, it should be understood that the terms “center”, “vertical”, “horizontal”, “length”, “width”, “thickness”, “top”, “bottom”, “front”, “back”, “left”, “right”, “vertical”, “horizontal”, “top”, “bottom”, “inside”, “outside”, “clockwise”, “counterclockwise”, “axial”, “radial”, “circumferential”, etc. for indicating the orientation or position relationship is based on the orientation or position relationship shown in the drawings, only for conveniently describing the present disclosure and simplifying the description, and not to indicate or imply that the indicated device or component must have a specific orientation, be constructed and operated in the specific orientation, and therefore can not be understood as a limitation of the present disclosure.

In addition, the terms “first” and “second” are only used to describe the purpose and can not be understood as indicating or implying relative importance or implying the quantity of indicated technical features. Therefore, the features limited to “first” and “second” can explicitly or implicitly include at least one of these features. In the description of the present disclosure, “multiple” means at least two, such as two, three, etc., unless there is an otherwise specific limitation.

In the present disclosure, unless there are otherwise specifications and limitations, the terms “installation”, “joint”, “connection”, “fixation” and other terms should be broadly understood, for example, they can be fixed connections, detachable connections, or integrated. It can be a mechanical connection or an electrical connection. It can be directly connected or indirectly connected through an intermediate medium. It can be the internal connection of two components or the interaction relationship between two components, unless there is the otherwise specific limitation. For ordinary skill in the art in this field, the specific meanings of the above terms in the present disclosure can be understood based on specific circumstances.

In the present disclosure, unless there are the otherwise specifications and limitations, the first feature is “above” or “below” the second feature which may be a direct contact between the first and second features, or the first features and the second features may be in indirect contact through an intermediate medium. Moreover, the first feature is “on”, “above”, and “over” the second feature can be that the first feature is directly or diagonally above the second feature, or only indicates that the first feature is horizontally higher than the second feature. The first feature is “beneath”, “below”, and “under” the second feature can be that the first feature is directly or diagonally below the second feature, or only indicate that the horizontal height of the first feature is less than that of the second feature.

It should be noted that when a component is referred to as “fixed to” or “set to” another component, it can be directly on another component or there can be a centered component. When a component is considered to be “connected” to another component, it can be directly connected to another component or there may be a centering component simultaneously. The terms “vertical”, “horizontal”, “top”, :down”, “left” and “right” and similar expressions used herein are only for the purpose of illustration and do not represent the only embodiment.

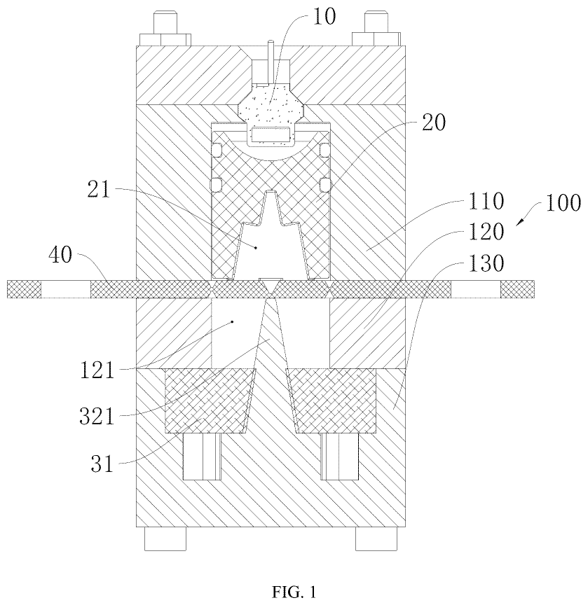

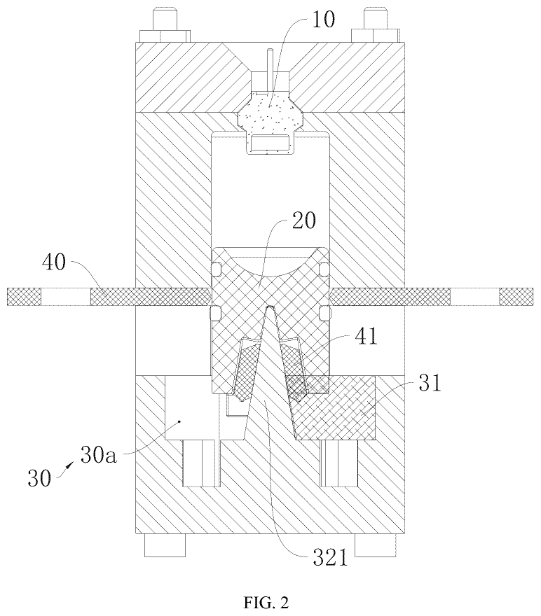

Referring to FIGS. 1 and 2, the present disclosure provides a fast circuit cutoff device. The fast circuit cutoff device includes a housing 100. An igniter 10, a piston 20, at least one arc extinguishing component 31 and a conductor 40 are provided in the housing 100. The conductor 40 penetrates through the housing 100. The igniter 10 and the piston 20 are located on a first side of the conductor 40. The at least one arc extinguishing component 31 is provided on a second side of the conductor 40. The igniter 10 is configured to drive the piston 20 to move towards the at least one arc extinguishing component 31 to a blocking state, so as to cut a part of the conductor 40 cut by the piston 20 into fragments 41 by the piston 20. Under the blocking state, the ends of the fragments 41 are inserted into the at least one arc extinguishing component 31 under a compression of an inner wall of an accommodating chamber 21.

The blocking state of the fast circuit cutoff device in the present disclosure is a state that the igniter 10 drives the piston 20 to move to an extremity position, and at this time, a part of the conductor 40 is cut by the piston 20 to cut off the circuit.

Specifically, the conductor 40 includes a pre designed weak portion, the igniter 10 drives the piston 20 to move towards the at least one arc extinguishing component 31, the piston 20 impacts the weak portion, so as to cut the part of the conductor 40 and form isolated insulation ends having a certain gap with each other, thereby realizing to cut off the circuit.

In the present disclosure, with the movement of the piston 20 towards the at least one arc extinguishing component 31, the piston 20 can compress an arcs carried by the fragments 41 to the at least one arc extinguishing component 31 to extinguish the arcs, thereby improving the insulation of the fast circuit cutoff device.

After the fragments 41 are in contact with the at least one arc extinguishing component 31, there is a possibility that the arc is conducted to the at least one arc extinguishing component 31 made of metal by a contact surface. If the arc, after conducting to the at least one arc extinguishing component 31, is in contact with the metal powder generated when the conductor 40 is cut off, there is a possibility of reigniting the arc. Therefore, it is necessary to reduce a contact area between the fragments 41 and the at least one arc extinguishing component 31 to reduce the risk of an arc reignition.

In the present disclosure, the ends of the fragments 41 are inserted into the at least one arc extinguishing component 31 under the blocking state. In a related art, fragments of a fast circuit cutoff device directly fall on an arc extinguishing component, and surfaces of the fragments with a larger area abut against the arc extinguishing component. However, in the present disclosure, the ends of the fragments with a smaller area are inserted into the arc extinguishing component 31 via an insertion manner, thereby reducing the possibility of conducting the arc to the arc extinguishing component 31, reducing the risk of the arc reignition and further improving the insulation of the fast circuit cutoff device.

In addition, the area of ends of the fragments 41 is relative small, force area of the fragments 41 is relative small when the fragments 41 are inserted into the at least one arc extinguishing component 31, so that the fragments 41 are easier to insert into the at least one arc extinguishing component 31, and a requirement for the igniter 10 is relatively low.

In some embodiments, the arc extinguishing component 31 can be a metal wire or other breathable materials capable of extinguishing the arc, which is not limited herein.

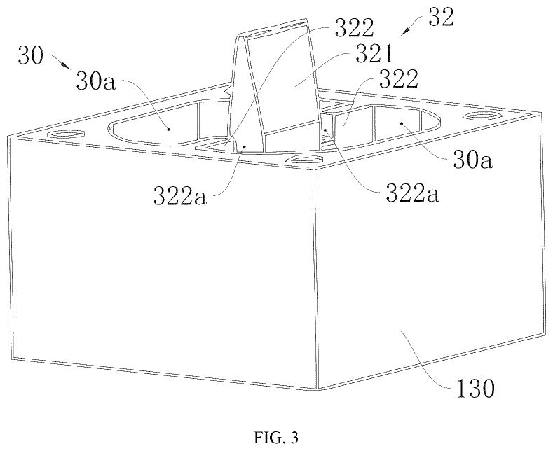

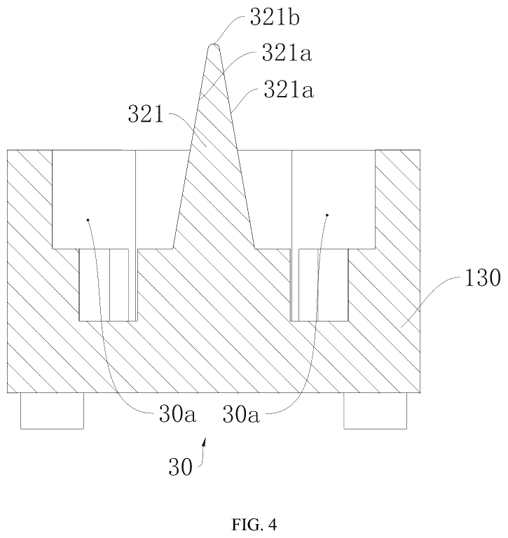

Referring to FIGS. 3 and 4, in some embodiments, the housing 100 includes an arc extinguish chamber 30. The arc extinguishing component 31 is disposed in the arc extinguish chamber 30. The arc extinguish chamber 30 includes a guiding surface 321a inclined relative to a movement direction of the piston 20. The fragments 41 can almost move along the movement direction of the piston 20 by abutting against the guiding surface 321a to deflect the fragments 41.

The guiding surface 321a herein can be an inner wall of the arc extinguish chamber 30 or other chambers, and can be a side surface of any component protruding from the arc extinguish chamber 30 or the other chambers, as long as which can be configured to abut against and deflect the fragments 41.

Specifically, at least a part of the guiding surface 321a corresponds to the fragments 41 along the movement direction of the piston 20, such that the fragments 41 fall to abut against the guiding surface 321a after cutting from the conductor 40 and under dead-weight and push of the piston 20, and is in contact with the guiding surface 321a under a guidance of the guiding surface 321a (i.e. the ends of the fragments 41 facing the at least one arc extinguishing component 31), thereby ensuring that the ends of the fragments 41 are capable of being inserted into the at least one arc extinguishing component 31.

Alternatively, it can provided other limiting components or guiding components to change orientations of the fragments 41, as long as it can ensure that the ends of the fragments 41 are at least partially inserted into the at least one arc extinguishing component 31, which is not limited herein.

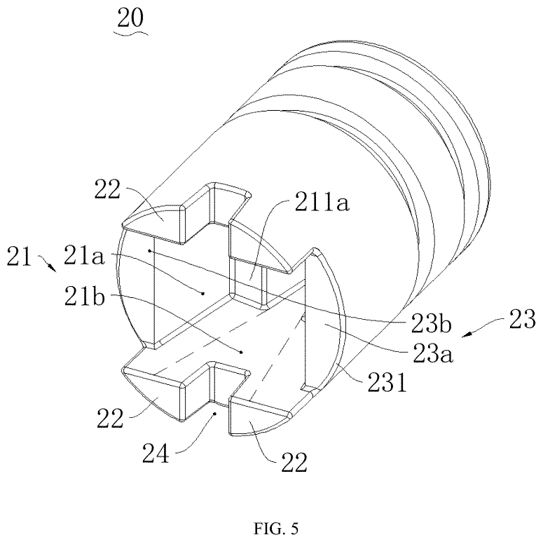

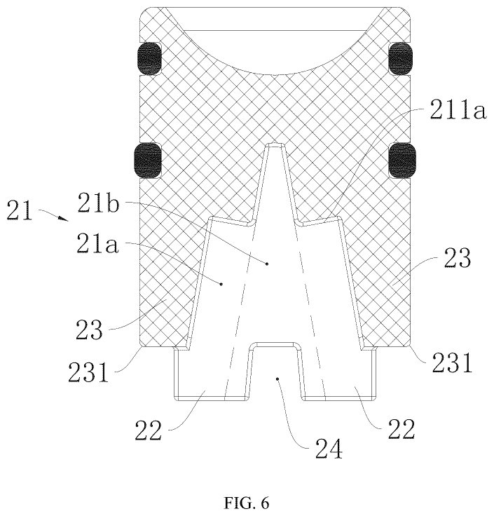

Referring to FIGS. 5 and 6, in some embodiments, an accommodating chamber 21 is defined on a side of the piston 20 towards the conductor 40, and the fragments 41 are accommodated in the accommodating chamber 21. Under the blocking state, the at least one arc extinguishing component 31 abuts against the piston 20 to block the accommodating chamber 21.

The fragments 41 are blocked in the accommodating chamber 21 by the at least one arc extinguishing component 31 and the piston 20, such blocking design can further reduce the possibility of an arc leakage, thereby improving the insulation of the fast circuit cutoff device.

In some embodiments, the angle between the guiding surface 321a and the movement direction of the piston is in a range of 0° to 20°. It should be understood that, the greater the angle between the guiding surface 321a and the movement direction of the piston 20, the greater the angle between each of the fragments 41, after abutting against the guiding surface 321a, and the movement direction of the piston 20, and the larger the contact area between each of the fragments 41, after inserting into the at least one arc extinguishing component 31, and the arc extinguishing component 31, which is not conducive to improving the insulation of the device, and the difficulty of each of the fragments 41 inserting the at least one arc extinguishing component 31 is higher. To avoid such phenomenon, after corresponding calculations and experimental verification to obtain that, the angle between the guiding surface 321a and the movement direction of the piston is in a range of 0° to 20°, the punch of the igniter 10 can meet a requirement of the fragments 41 inserting into the at least one arc extinguishing component 31.

Referring to FIGS. 5 and 6, in some embodiments, an end of the piston 20 towards the at least one arc extinguishing component 31 includes a columnar portion 22. Since the fragments 41 are accommodated in the accommodating chamber 21 under the blocking state, to insert the fragments 41 into the at least one arc extinguishing component 31, it is necessary to insert a part of the piston 20 into the at least one arc extinguishing component 31. By the columnar portion 22 provided on the end of the piston 20 towards the at least one arc extinguishing component 31, the columnar portion 22 can reduce a force area of the bottom of the piston 20, which is conducive to inserting the piston 20 into the at least one arc extinguishing component 31.

In some embodiments, the widths of the fragments 41 are smaller than the width of other part of the conductor 40, under an initial state, the fragments 41 are snapped between two columnar portions 22, which is conducive to being effective in preventing installation errors, and ensuring that, after the piston 20 is installed, a cutting edge 231 of the piston 20 is corresponding to the weak portion of the conductor 40.

In some embodiments, under the blocking state, the depth of the piston 20 inserting into the at least one arc extinguishing component 31 is less than or equal to 3 mm. By inserting the piston 20 into the at least one arc extinguishing component 31, on one hand, it can fully isolate the fragments 41 in corresponding fragment-holding cavities 21a, thereby improving the insulation of the device; on the other hand, it can further provide a certain buffering effect. After the calculations and the experimental verification, when the inserting depth of the piston 20 is less than or equal to 3 mm, the buffering effect and an arc extinguishing effect are best.

Referring to FIGS. 5 and 6, in some embodiments, a side of the piston 20 towards the conductor 40 includes two cutting portions 23 defined as a first cutting portion 23a and a second cutting portion 23b, respectively. The accommodating chamber 21 is located between the first cutting portion 23a and the second cutting portion 23b. The first cutting portion 23a and the second cutting portion 23b each include the cutting edge 231. The cutting edge 231 of the first cutting portion 23a is located on an end of the first cutting portion 23a away from the second cutting portion 23b. The cutting edge 231 of the second cutting portion 23b is located on an end of the second cutting portion 23b away from the first cutting portion 23a. The side of the columnar portion 22 towards the at least one arc extinguishing component 31 protrudes from an end surface of the piston 20 where the cutting edge 231 is located.

By providing the cutting edge 231 on ends of the first cutting portion 23a and the second cutting portion 23b, it may increase a gap between two weak portions of the conductor 40 as far as possible, so as to increase a distance of the isolated insulation ends after the fragments 41 are cut, thereby improving the insulation effect.

Referring to FIGS. 2 and 3, in some embodiments, a spacer assembly 32 is fixedly provided in the arc extinguish chamber 30. The spacer assembly 32 includes a protrusion portion 321, in which the guiding surface 321a is a sidewall of the protrusion portion 321. The accommodating chamber 21 includes a fitting cavity 21b corresponding to the protrusion portion 321. Under the blocking state, the protrusion portion 321 is inserted into the fitting cavity 21b and in contact with the inner wall of the fitting cavity 21b, such that the protrusion portion 321 and the inner wall of the accommodating chamber 21 enable the fragments 41 to be vertically clamped.

Being vertically clamped herein is the fragments 41 being clamped at a state of the ends of the fragments 41 towards or departing from the igniter 10, and at this time, the protrusion portion 321 and the inner wall of the accommodating chamber 21 abut against a pair of the end surfaces of the fragments 41 towards or departing from the igniter 10, respectively, when the fragments 41 are not cut off.

In a related art, a part of the fast circuit cutoff device, in order to improve an arc extinguishing ability, arc extinguishing mediums (such as metal wires, arcing grid pieces and so on) are usually added or cutting ends are increased to realize a fast arc extinguishing. However, it generally requires a relative large arc extinguishing space, which may lead to a large size of the device, and can not be used in fields such as new energy vehicles and so on for a miniaturization requirement of the circuit cutting-off device.

In the present disclosure, the vertical fragments 41 can be clamped and accommodated between the protrusion portion 321 and the accommodating chamber 21 via the guiding surface 321a of the protrusion portion 321 and the inner wall of the accommodating chamber 21. Since a thickness of the fragments 41 is relative small, such way of accommodating the fragments 41 can reduce a requirement of the diameter of the housing 100, so as to reduce a whole size of the fast circuit cutoff device as far as possible.

In addition, in the first aspect, under the blocking state, the two cutting portions 23 are blocked between the fragments 41 and the ends of the conductor 40, so as to reduce and block the arc therebetween, thereby further improving current breaking capacity of the fast circuit cutoff device in the present disclosure.

In the second aspect, under the blocking state, the protrusion portion 321 is inserted into and fits with the fitting cavity 21b, which can reduce a gap between the protrusion portion 321 and the piston 20 as far as possible, not only reducing the possibility of the arc leaking through the gap, but also improving a space utilization rate in the housing 100 and further reducing the size of the fast circuit cutoff device.

Referring to FIG. 6, in some embodiments, a blocking surface 211a is provided in the accommodating chamber 21. Under the blocking state, the blocking surface 211a abuts against one of fracture surfaces of the fragments 41 along the movement direction of the piston 20, so as to compress the fragments 41 into the arc extinguishing component 31 by the blocking surface 211a when the piston 20 moves towards the at least one arc extinguishing component 31.

Referring to FIGS. 2 and 6, in some embodiments, the accommodating chamber 21 further includes a plurality of fragment-holding cavities 21a defined by the inner wall of the fitting cavity 21b and/or the protrusion portion 321. Each of the plurality of fragment-holding cavities 21a is corresponding to each of the fragments 41. The blocking surface 211a is the inner wall of the fragment-holding cavity 21a towards the igniter 10. Under the blocking state, each of the fragments 41 is accommodated in corresponding one of the plurality of the fragment-holding cavities 21a. A pair of the end surfaces of each of the fragments 41 abuts against the protrusion portion 321 and the inner wall of each of plurality of the fragment-holding cavities 21a, respectively.

Taking that the plurality of the fragment-holding cavities 21a being defined on the piston 20 as an example, by defining the plurality of the fragment-holding cavities 21a in the piston 20, the fragments 41 are accommodated in the piston 20. Under the blocking state, the piston 20, the fragment 41 and the protrusion portion 321 are in tightly contact with each other, which can improve a space utilization rate and reduce a size of the device on one hand. On the other hand, it can reduce the possibility of leaking the arcs carried by the fragments 41, thereby improving the insulation performance of the device.

In some embodiments, the side surface of the protrusion portion 321 can be in an interference fit with the inner wall of the fitting cavity 21b, so as to separate each of the plurality of fragment-holding cavities 21a. By the interference fit between the protrusion portion 321 and the inner wall of the fitting cavity 21b, the phenomenon that the arcs carried by the fragments 41 in the different fragment-holding cavities 21a are conducted to each other via the gap between the protrusion portion 321 and the inner wall of the fitting cavity 21b can be prevented, thereby improving the insulation effect of the device.

In some embodiments, the spacer assembly 32 includes at least one protrusion portion 321 and at least one spacer 322. The spacer 322 can divide the arc extinguish chamber 30 into a plurality of arc extinguishing cavities 30a, and the arc extinguishing components 31 are each independently disposed in each of the plurality of arc extinguishing cavities 30a. The protrusion portion 321 includes at least one dividing edge 321b, so as to cut a part of the conductor 40 cut by the piston 20 into a plurality of the fragments 41 when the piston 20 moves towards the at least one arc extinguishing component 31, and each of the plurality of the fragments 41 is corresponding to one of the plurality of arc extinguishing cavities 30a and one of the plurality of fragment-holding cavities 21a. Under the blocking state, each of the fragments 41 is isolated in the corresponding one of the plurality of the fragment-holding cavities 21a by the piston 20, the spacer 322 and the arc extinguishing component 31., At least a part of the fragment-holding cavity 21a is located in corresponding one of the plurality of the arc extinguishing cavities 30a.

By cutting the part of the conductor 40 cut by the piston 20 into the plurality of the fragments 41, it can reduce a size of each of the plurality of fragments 41, an arc carry capacity of the fragments 41, and the possibility of the arc leakage. In addition, by providing independent arc extinguishing components 31 in each of the plurality of arc extinguishing cavities 30a and isolating each of the fragments 41 into the corresponding each of the plurality of arc extinguishing cavities 30a, the phenomenon that the arc carried by the fragments 41 is conducted to each other via the arc extinguishing components 31 made of metal can be prevented, thereby further reducing the possibility of the arc reignition and leakage, and improving the insulation effect of the device.

Referring to FIGS. 3 and 5, in some embodiments, at least one group of the spacer assembly 32 is fixedly provided in the arc extinguish chamber 30. Each group of the spacer assembly 32 includes one protrusion portion 321 and one spacer 322, which is configured to divide the arc extinguish chamber 30 into two arc extinguishing cavities 30a. The protrusion portion 321 includes a dividing edge 321b and two guiding surfaces 321a located at two sides of the dividing edge 321b, in which the dividing edge 321b can cut the part of the conductor 40 cut by the piston 20 into two fragments 41.

The part of the conductor 40 cut by the piston 20 also includes a weak portion corresponding to the dividing edge 321b, and the weak portion of the part of the conductor 40 is cut off by the dividing edge 321b, so as to obtain two fragments 41.

In one or more embodiments, the weak portion of the part of the conductor 40 corresponding to the dividing edge 321b is located on a center of the part of the conductor 40, so that the length of the two fragments 41 after cutting are equal, which can ensure that the two fragments 41 can be both inserted into the arc extinguishing components 31, thereby improving the insulation performance of the device. Furthermore, a phenomenon that an accommodating space increases when a length of one of the two fragments 41 is excessively long can be prevented, and the size of the device can be reduced.

Referring to FIG. 1, in some embodiments, in the initial state, the cutting edge 231 and the dividing edge 321b abut against two end surfaces of the conductor 40, respectively. In the first aspect, after the igniter 10 is fired, the piston 20 can cut the corresponding weak position at first time by the cutting edge 231, so as to form isolated insulation ends in the conductor 40, and complete a cut off of the circuit. In the second aspect, the piston 20 cuts the part of the conductor 40 and further moves downwards, such part of the conductor 40 is rotated around the dividing edge 321b as a center by a compression of the piston 20, at this time, the ends of the fragments 41 depart from the ends of the conductor 40 in a relatively fast speed, and at same time, the cutting portions 23 may block between the ends of the fragments 41 and the ends of the conductor 40, so as to reduce and block the arc, thereby improving the insulation performance of the device.

Referring to FIG. 1, in some embodiments, the housing 100 includes a top housing 110, a conductor-fixing component 120 and a bottom housing 130 capable of fixing with each other. The conductor 40 is fixed on the conductor-fixing component 120, the arc extinguish chamber 30 is defined on the bottom housing 130, a through hole 121 is defined on and penetrates through the conductor-fixing component 120. The piston 20 can move along the inner wall of the through hole 121, and a part of the protrusion portion 321 is located in the through hole 121.

The piston 20 can move in the through hole 121, enabling the piston 20 to cut the fragments 41 from the conductor 40, while the piston 20 is inserted into the through hole 121. Furthermore, a narrow gap is formed between the piston 20 and the inner wall of the through hole 121, thereby reducing the arc in time.

Referring to FIG. 3, in some embodiments, an end surface of the bottom housing 130 towards the conductor-fixing component 120 is at an equal horizontal height as to the spacer 322.

It should be understood that, in order to ensure the insulation performance of the device, the conductor-fixing component 120 is required to tightly fit with the end surface of the bottom housing 130 and the spacer 322, respectively. The conductor-fixing component 120 abuts against the end surface of the bottom housing 130 to ensure that the spacer 322 divide the arc extinguish chamber 30 into a plurality of arc extinguishing cavities 30a, and prevent the arcs carried by the fragments 41 in the different arc extinguishing cavities 30a to be conducted to each other.

Therefore, by making the spacer 322 to be at the equal horizontal height to the side end surface of the conductor-fixing component 120, a side surface of the conductor-fixing component 120 towards the bottom housing 130 being a flush surface is required, so as to realize a tight fit among the conductor-fixing component 120, the bottom housing 130 and the spacer 322, thereby reducing design and machining difficulties of the conductor-fixing component 120.

Alternatively, a part of the spacer 322 can protrude or be recess relative to the end surface of the bottom housing 130, as long as the conductor-fixing component 120 includes a concave portion or a protrusion portion corresponding to the spacer 322, the conductor-fixing component 120 can be in tightly contact with both the end surface of the bottom housing 130 and the spacer 322 at same time.

Referring to FIGS. 1 and 3, in some embodiments, a side surface of the bottom housing 130 towards the conductor-fixing component 120, the arc extinguishing component 31 and the spacer 322 are at an equal horizontal height. An avoidance slot is defined on at least one of the spacer 322 and the piston 20, such that the end of the piston 20 towards the at least one arc extinguishing component 31 is inserted into the at least one arc extinguishing component 31, so as to prevent an interference between the piston 20 and the spacer 322 when the piston 20 is inserted into the at least one arc extinguishing component 31.

The arc extinguishing component 31 is at the equal horizontal height to the end surface of the bottom housing 130 towards the conductor-fixing component 120, so as to ensure that the arc extinguishing component 31 is in tightly contact with the end surface of the bottom housing 130 towards the conductor-fixing component 120. It can prevent arcs leakage from the gap between the bottom housing 130 and the conductor-fixing component 120, thereby improving the insulation strength of the device.

In some embodiments, an avoidance slot is both provided on the spacer 322 and the piston 20, so as to fit with each other. For example, a spacer avoidance slot 322a is defined on the spacer 322 and a piston avoidance slot 24 is defined on the piston 20.

If the avoidance slot is only defined on one of the spacer 322 and the piston 120, a requirement for the assembly accuracy is relative high. Taking that the spacer avoidance slot 322a is defined on the spacer 322 as an example, with the movement of the piston 20 towards the at least one arc extinguishing component 31, if the piston 20 sharks or deviates off along a radial direction of the piston 20, the piston 20 may interfere the spacer 322 and can not be inserted into the spacer avoidance slot 322a. However, once a width of the spacer avoidance slot 322a along a radial direction of the piston 20 is increased, it can reduce the requirement for the design and the assembly accuracy, but may result in a gap between the piston 20 and the spacer avoidance slot 322a under the blocking state, which is not conducive to improving the insulation performance of the device.

On the contrary, only taking that the piston avoidance slot 24 is defined on the piston 20 as an example, with the movement of the piston 20 towards the at least one arc extinguishing component 31, if the piston 20 deviates off along a circumferential direction of the piston 20, the spacer 322 may interfere the piston 20 and cannot be inserted into the piston avoidance slot 24. However, once the width of the piston avoidance slot 24 along a circumferential direction of the piston 20 is increased, it can reduce the requirement for the design and the assembly accuracy, but may result in the gap between the piston 20 and the spacer avoidance slot 322a under the blocking state, which is not conducive to improving the insulation performance either.

In the above embodiments, by defining the avoidance slots corresponding to each other on the spacer 322 and the piston 20, when the piston 20 moves towards the at least one arc extinguishing component 31, the piston avoidance slot 24 fits with the spacer avoidance slot 322a. An avoidance space corresponding to two avoidance slots is larger than a avoidance space corresponding to a single avoidance slot, the piston 20 includes a certain moving allowance along the radial direction and the circumferential direction of the piston 20, it can normally complete a fit of the piston 20 as long as the deviation or the deflection of the piston 20 does not exceed the moving allowance, thereby effectively reducing the requirement for the design and the assembly accuracy of the device.

In some embodiments, a depth of the piston avoidance slot 24 is equal to a depth of the spacer avoidance slot 322a. It should be understood that, the piston avoidance slot 24 fits with the spacer avoidance slot 322a to obtain a dual-direction moving allowance. If the depth of the piston avoidance slot 24 is different to that of the spacer avoidance slot 322a, when a movement distance of the piston 20 exceeds the avoidance slot with a relative small depth after fitting, and at this time, a real fit effect is equal to that with a single avoidance slot, only the avoidance slot with the relative large depth can provide a single-direction moving allowance for the piston 20.

By providing an equal depth of the piston avoidance slot 24 and the spacer avoidance slot 322a, when a total depth of the piston avoidance slot 24 and the spacer avoidance slot 322a is certain, it enables that the piston 20 has a largest distance of the dual-direction moving allowance, so as to prevent an interference between the piston 20 and the spacer 322 as far as possible, thereby reducing the requirement for the design and the assembly accuracy of the device.

The various technical features of the above embodiments can be combined in any way. To make the description concise, all possible combinations of the various technical features in the above embodiments have not been described. However, as long as there is no contradiction in the combination of these technical features, they should be considered within the scope of the specification.

The above embodiments only illustrate some embodiments of the present disclosure, and the description of the embodiments is specific and detailed, but it should not be understood as a limitation on the scope of the present disclosure. It should be understood that, for ordinary skill in the art, appropriate variations and improvements can be made without departing from the substantial spirit of the present disclosure, all of which fall within the scope of protection of the present disclosure. Therefore, the scope of the present disclosure should be based on the attached claims.

What is claimed is:

1. A fast circuit cutoff device, comprising a housing, an igniter, a piston, at least one arc extinguishing component and a conductor, the igniter, the piston and the at least one arc extinguishing component are provided in the housing, the conductor penetrates through the housing, the igniter and the piston are located on a first side of the conductor, and the at least one arc extinguishing component is provided on a second side of the conductor;
the igniter is configured to drive the piston to move towards the arc extinguishing component to a blocking state, so as to cut a part of the conductor into fragments by the piston; and
under the blocking state, ends of the fragments are inserted into the at least one arc extinguishing component under a compression of the piston.

2. The fast circuit cutoff device of claim 1, wherein the housing comprises an arc extinguish chamber, the at least one arc extinguishing component is disposed in the arc extinguish chamber, the arc extinguish chamber comprises a guiding surface inclined relative to a movement direction of the piston, and the fragments are deflected by abutting against the guiding surface.

3. The fast circuit cutoff device of claim 2, wherein an accommodating chamber is defined on a side of the piston towards the conductor, and the fragments are accommodated in the accommodating chamber; and
under the blocking state, the arc extinguishing component abuts against the piston to block the accommodating chamber.

4. The fast circuit cutoff device of claim 3, wherein the accommodating chamber comprises a blocking surface, and under the blocking state, the blocking surface abuts against one of fracture surfaces of the fragments along the movement direction of the piston.

5. The fast circuit cutoff device of claim 4, wherein an end of the piston towards the arc extinguishing component comprises a columnar portion.

6. The fast circuit cutoff device of claim 4, wherein a protrusion portion is fixedly provided in the arc extinguish chamber, the guiding surface is a sidewall of the protrusion portion, the accommodating chamber comprises a fitting cavity corresponding to the protrusion portion, and under the blocking state, the protrusion portion is inserted into the fitting cavity and abuts against an inner wall of the fitting cavity.

7. The fast circuit cutoff device of claim 6, wherein the accommodating chamber further comprises a fragment-holding cavity defined on the inner wall of the fitting cavity, the blocking surface is an inner wall of the fragment-holding cavity towards the igniter, and under the blocking state, the fragments are accommodated in the fragment-holding cavity.

8. The fast circuit cutoff device of claim 3, wherein at least one protrusion portion capable of inserting into the accommodating chamber is fixedly provided in the arc extinguish chamber, and the at least one protrusion portion comprises a dividing edge, and the dividing edge of the at least one protrusion portion is configured to further cut the part of the conductor cut by the piston into a plurality of fragments when the piston moves towards the arc extinguishing component.

9. The fast circuit cutoff device of claim 8, wherein one protrusion portion is fixedly provided in the arc extinguish chamber, and configured to further cut the part of the conductor cut by the piston into two fragments.

10. The fast circuit cutoff device of claim 8, wherein, under the blocking state, the at least one protrusion portion abuts against an inner wall of the accommodating chamber, so as to divide the accommodating chamber into a plurality of fragment-holding cavities separated from each other, and each of the plurality of fragment-holding cavities is configured to accommodate one of the plurality of fragments.
